(19) United States
(12) Patent Application Publication
(10) Pub. No.: US 2020/0062196 A1
(43) Pub. Date: Feb. 27, 2020

(54) SEGMENTED HEADLINER

(71) Applicant: FORD GLOBAL TECHNOLOGIES, LLC, Dearborn, MI (US)

(72) Inventors: Paul Alan Forgette, Brownstown, MI (US); Amy M. Boardman, Garden City, MI (US); John Andrew Stakoe, Bloomfield Hills, MI (US); Anna Miller Hill, Belleville, MI (US); Robert Ralph Armitage, JR., Howell, MI (US)

(21) Appl. No.: 16/107,856

(22) Filed: Aug. 21, 2018

(51) Int. Cl. B60R 13/02

(52) U.S. Cl. CPC B60R 13/0225; B60R 2021/0442; B60R 13/0206

(57) ABSTRACT

A segmented headliner includes a plurality of segments connected together and outlining a central opening.

### TECHNICAL FIELD

This document relates generally to the motor vehicle equipment field and, more particularly, to a new and improved headliner made from a plurality of segments.

### BACKGROUND

State of the art processes for producing vehicle headliner or overhead systems rely upon many different types of materials, tools and processes from various supplier companies. Those supplier companies may be located near and far from the original equipment manufacturer and a complex network of shipping logistics is required to ensure production schedules are met. In addition, many types of tools, equipment, processes, materials and people are required to assemble the various parts into the vehicle headliner or overhead system.

In the past a central opening was cut in the headliner for panorama and sun roof assembly features. The removed central section was effectively rendered scrap for the landfill. Advantageously, the new segmented headliner reduces the material costs, environmental costs and landfill costs associated with this removed central section. As a result, the segmented headliner is produced in a more cost effective and efficient manner.

In addition, each segment of the headliner includes a headliner substrate thermoformed from a polypropylene glass matte technology (PP/GMT) blank and a secondary component simultaneously injection molded onto the headliner substrate in a new combined hybrid process that culminates in a subsequent step of laminating a surface covering of the headliner substrate. By simultaneously molding the secondary components to the headliner substrate of each headliner segment as the headliner substrate is being formed, engineering/design time, part cost and tooling efficiencies are improved by reducing many of the component tools, processes and logistics that are required to make the motor vehicle headliner or overhead system.

This document relates to a new and improved headliner assembled from a plurality of segments that may be connected together and outline a central opening for a panorama roof, a sun roof assembly or other feature as desired by the customer.

### SUMMARY

In accordance with the purposes and benefits as described herein, a new and improved headliner is provided. That headliner comprises a plurality of segments connected together and outlining a central opening. The plurality of segments may include a first segment, a second segment, a third segment and a fourth segment. In one of many possible embodiments, the first segment is a front header, the second segment is a rear header, the third segment is a right hand side rail and the fourth segment is a left hand side rail.

Each of the plurality of segments may comprise a unitary body including (a) a substrate having an A surface and a B surface, (b) a secondary component carried on the B surface and (c) a laminated surface covering the A surface.

In at least one of the many possible embodiments of the segmented headliner, the secondary component may comprise (a) a first flange on a first segment of the plurality of segments, (b) a second flange on the second segment of the plurality of segments and (c) a fastening feature securing the first flange and the second flange together in an overlapping relationship.

That fastening feature may comprise a snap tab carried on the first flange and a snap tab receiver carried on the second flange. In an alternative embodiment, the fastening feature may comprise a heat stake fusing the first flange to the second flange. In yet another possible embodiment, the fastening feature may comprise an adhesive securing the first flange to the second flange.

In still another possible embodiment, the fastening feature may comprise a snap fastener received in a first fastener receiver in the first flange and a second fastener receiver in the second flange. In still yet another possible embodiment, the fastening feature may comprise a clamp having a channel receiving the first flange and the second flange and joining the two flanges together.

The secondary component on at least one of the right hand side rail and the left hand side rail may comprise a side air curtain deployment feature. The secondary component on at least one of the plurality of segments may comprise an integral attachment feature. That integral attachment feature may comprise a bracket. In one particularly useful embodiment, that bracket may include a receiver adapted to receive a magnetic fastener or the type utilized to secure the segmented headliner to the sheet metal roof substrate of the motor vehicle. In other embodiments, the secondary component on at least one of the plurality of segments may comprise an integral reinforcement. That integral reinforcement may comprise a plurality of ribs.

In yet another possible embodiment, the secondary component on at least one of the plurality of segments may comprise an integral energy absorbing feature. Still further, in yet another possible embodiment, the secondary component on at least one of the plurality of segments may comprise a portion of a trim ring adapted to outline and reinforce the central opening of the segmented headliner.

In one or more of the many possible embodiments of the segmented headliner, the substrate may be made from polypropylene glass matte technology (PP/GMT). The secondary component may be made from a material selected from a group consisting of glass or mineral filled polypropylene and combinations thereof. In addition, the surface covering may be made from a material selected from a group consisting of woven/knit cloth, suede/leather, non-woven, different types of films (woodgrain, metallic, camo, carbon fiber, etc.) and combinations thereof.

In the following description, there are shown and described several preferred embodiments of the segmented headliner. As it should be realized, the segmented headliner is capable of other, different embodiments and its several details are capable of modification in various, obvious aspects all without departing from the segmented headliner as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the segmented headliner and together with the description serve to explain certain principles thereof.

FIG. 1 is a bottom plan view of the segmented headliner illustrating the plurality of segments that are connected together and outline a central opening.

FIG. 2 illustrates the four individual segments of the segmented headliner illustrated in FIG. 1 with the front and rear header segments held in a first platen and the left paint and right hand side rail segments held in a second platen.

FIG. 3A illustrates a first possible embodiment of the segmented headliner wherein the first segment and the second segment are joined by a fastening feature including a snap tab carried on a first flange and a snap tab receiver carried on a second flange.

FIG. 3B illustrates an alternative embodiment of the segmented headliner wherein the fastening feature comprises a heat stake fusing a first flange on the first segment to a second flange on the second segment.

FIG. 3C illustrates an alternative embodiment including a fastening feature comprising an adhesive, in the form of a hot melt, securing the first flange on the first segment to the second flange on the second segment.

FIG. 3D illustrates another alternative embodiment including a fastening feature in the form of a snap fastener that is received in a first fastener receiver in the first flange of the first segment and a second fastener receiver in the second flange of the second segment.

FIG. 3E illustrates yet another alternative embodiment of the segmented headliner including a fastening feature in the form of a clamp having a channel receiving a first flange of the first segment and a second flange of the second segment and holding those two flanges together.

FIG. 4 is a perspective view of one possible embodiment of the headliner substrate wherein the illustrated segment includes a secondary component in the form of a side air curtain deployment feature.

FIG. 5 is a perspective view of one possible embodiment of the segmented headliner wherein the illustrated segment includes a secondary feature in the form of a bracket and an integral reinforcement in the form of a plurality of ribs.

FIG. 6 is a view of yet another alternative embodiment of the segmented headliner wherein the illustrated segment incorporates a secondary component in the form of a bracket adapted to receive a magnetic fastener used to secure the finished segment to the metal roof substrate of a motor vehicle.

FIG. 7 is a view of yet another alternative embodiment of the segmented headliner wherein the illustrated segment includes a secondary component in the form of a portion of a trim ring adapted to receive and reinforce the central opening for a panorama roof or a sun roof assembly.

FIG. 8 is a detailed perspective view of a portion of an energy absorbing rib structure of the type that may be injection molded onto the B surface of the substrate of a segment of the segmented headliner.

FIG. 9 is a schematic illustration of the method for producing the headliner illustrating (a) the oven for heating the blank from which the headliner substrate of each segment is thermoformed, (b) the combined thermoforming and injection molding apparatus that thermoforms the blank into the headliner substrate and injection molds a secondary component onto the B surface of the headliner substrate and (c) the laminating press utilized to subsequently laminate a surface covering onto the A surface of the headliner substrate.

FIG. 10 is a view similar to FIG. 1 but showing an alternative embodiment of the headline substrate incorporating a fifth segment closing the central opening and forming a continuous headliner for a full roof motor vehicle.

Reference will now be made in detail to the present preferred embodiments of the segmented headliner, examples of which are illustrated in the accompanying drawing figures.

### DETAILED DESCRIPTION

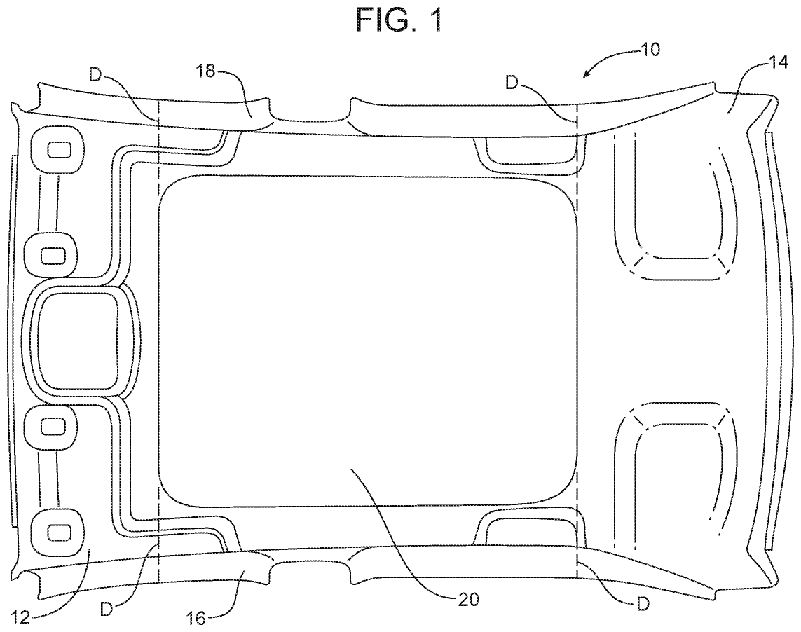

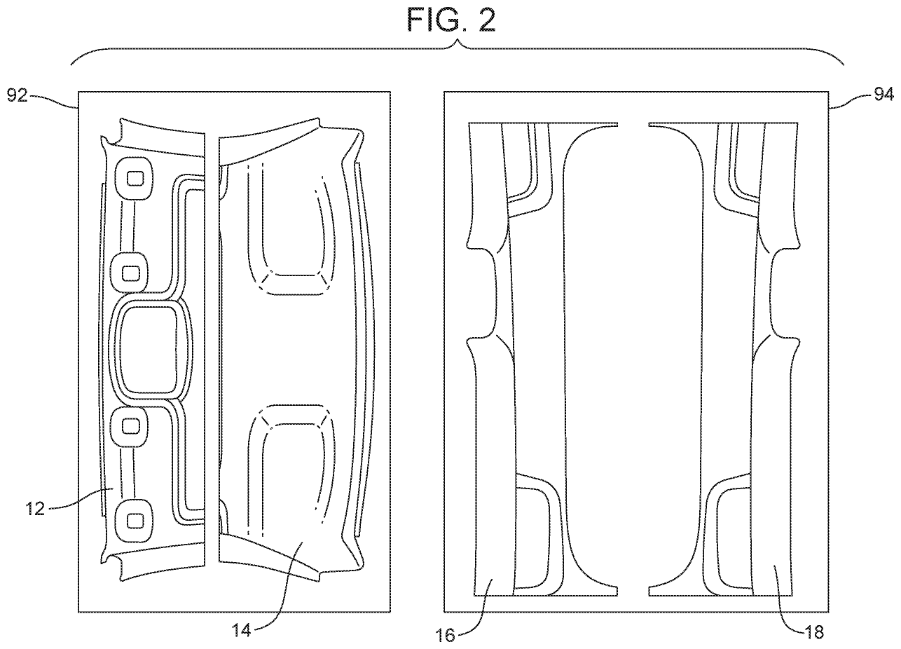

Reference is now made to FIGS. 1 and 2 illustrating the new and improved headliner 10 made from a plurality of segments 12, 14, 16, 18 that are connected together and outline a central opening 20. The central opening 20 may be adapted to receive a panorama roof section, a sun roof assembly, a standard central roof section or a central roof section with substantially any desired optional feature known in the automotive arts.

In the illustrated embodiment, the first segment 12 is a front header, the second segment 14 is a rear header, the third segment 16 is a right hand side rail and the fourth segment 18 is a left hand side rail. The dashed lines D generally illustrate where the four segments 12, 14, 16, 18 are joined together.

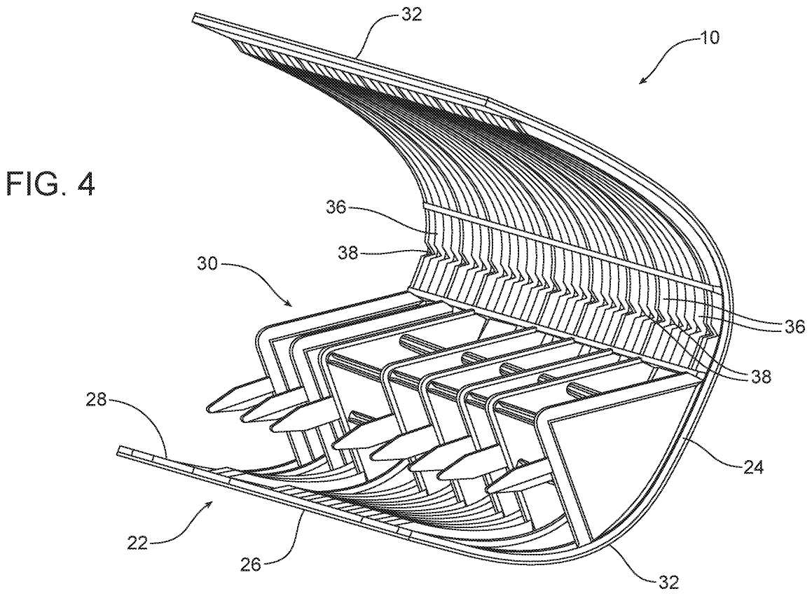

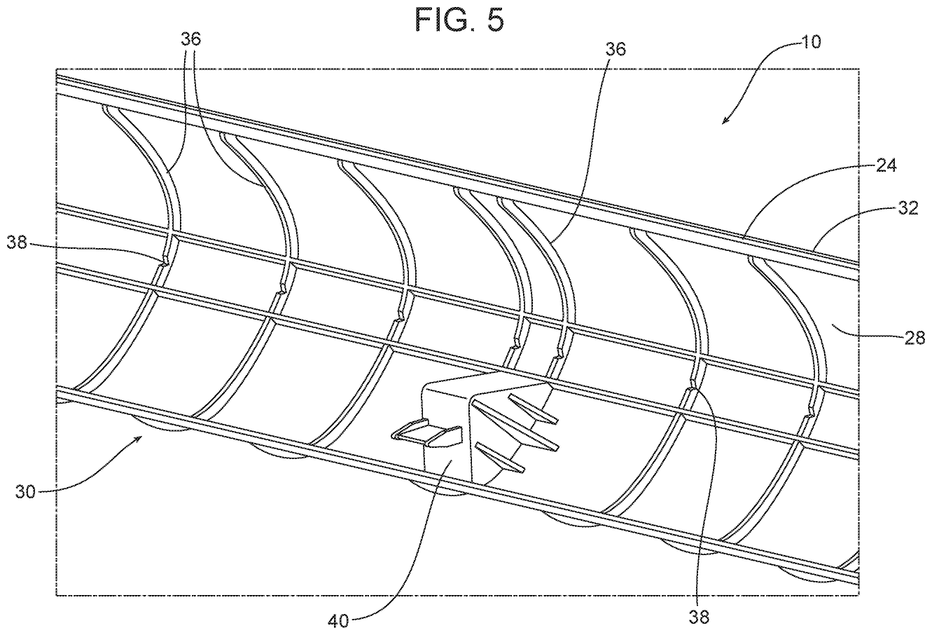

Each of the segments, 12, 14, 16, 18 may include a unitary body 22 including (a) a substrate 24 having an A surface 26 and a B surface 28, (b) a secondary component 30 carried on the B surface and (c) a laminated surface covering 32 covering the A surface. See, for example, FIGS. 4 and 5.

As will be described in greater detail below, the substrate may be formed from a polypropylene glass matte technology (PP/GMT) blank B. The secondary component 30 may be injected molded from a material that is compatible with and will fuse with the polypropylene substrate material. That secondary component material may be selected from a group consisting of glass or mineral filled polypropylene and combinations thereof. The surface covering 32 may be made from any appropriate cover material including, but not necessarily limited to a material selected from a group consisting of woven/knit cloth, suede/leather, non-woven, different types of films (woodgrain, metallic, camo, carbon fiber, etc.) and combinations thereof.

In the embodiment illustrated in FIG. 4, the secondary component 30 comprises a side air curtain deployment feature incorporating a plurality of ribs 36 having notches 38 configured to allow the substrate 24 to flex in a precise and repeatable manner for proper air curtain deployment.

In the embodiment of the headliner 10 illustrated in FIG. 5 the secondary component 30 comprises an integral attachment feature in the form of a bracket 40 and an integral reinforcement in the form of a plurality of ribs 36. The bracket 40 may be adapted to secure the headliner 10 to part of the metal superstructure of the motor vehicle or adapted to receive a fastener to secure another component, such as a coat hook or grab handle, to the headliner. The reinforcement ribs 36 may be adapted to retain the shape of the headliner 10 when the headliner is secured to the roof substrate (not shown) of the motor vehicle. The ribs 36 may also include notches 38 if desired. The ribs 36 may also manage energy absorbing requirements.

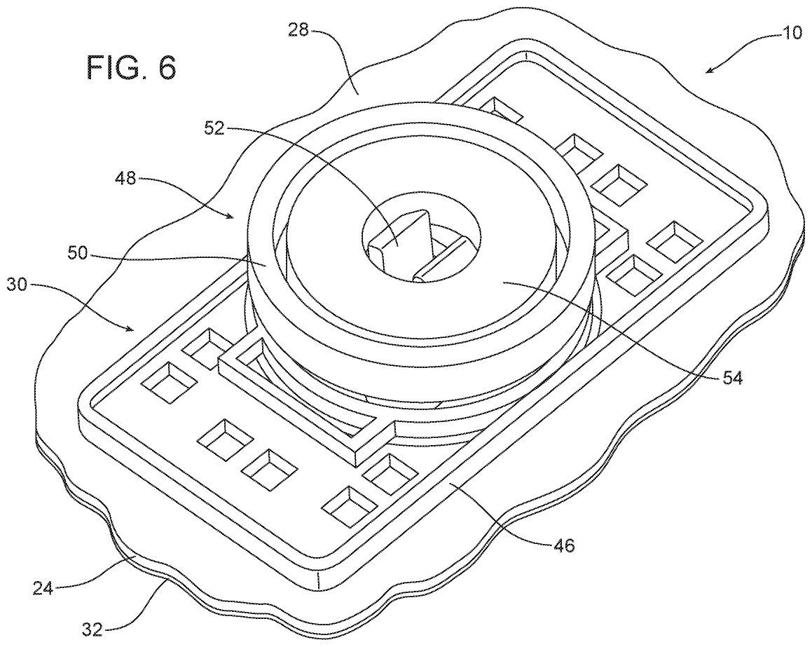

FIG. 6 illustrates yet another alternative embodiment of the headliner 10 wherein the secondary component 30 comprises a bracket 46 adapted to receive and hold a magnetic fastener 48 of a type utilized to secure the headliner to its sheet metal roof substrate of the motor vehicle. The magnetic fastener 48 is secured to the bracket 46. In the illustrated embodiment, that magnetic fastener 48 includes a cup or umbrella 50 fixed to the post 52 of the bracket 46. The cup 50 receives and holds a magnet 54.

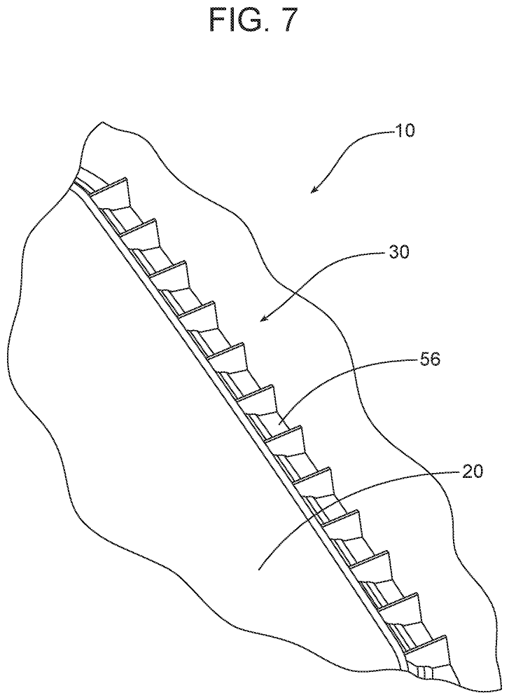

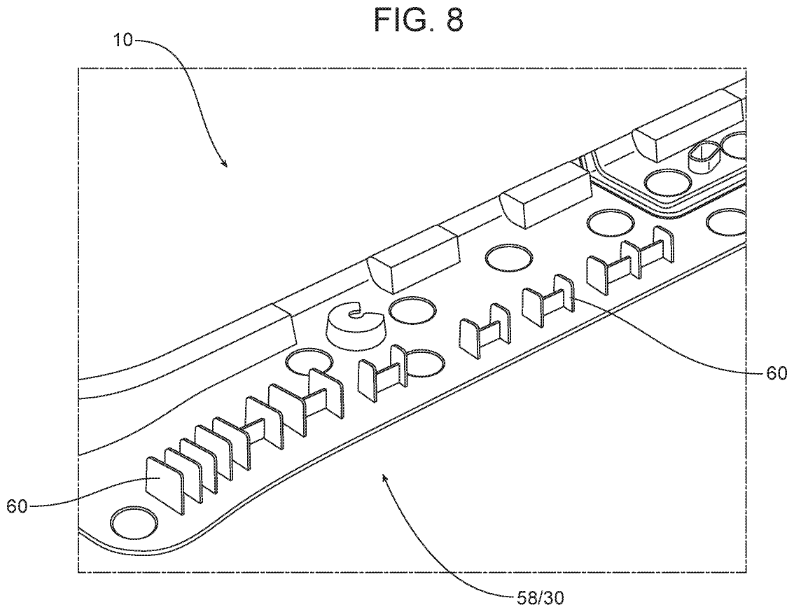

In the embodiment illustrated in FIG. 7, the headliner 10 includes a secondary component 30 in the form of a portion of a trim ring 56 that is adapted to outline the central opening 20. As should be appreciated, the trim ring 56 functions to reinforce the headliner 10 so that the headliner better holds its shape around the central opening.

FIG. 8 illustrates an integral energy absorbing feature 58 that may be the secondary component 30 on yet another embodiment of the headliner 10. More particularly, that energy absorbing feature 58 includes a plurality of ribs 60 adapted to absorb energy in the event of an impact of the head or other part of an occupant against the headliner in an effort to mitigate injury.

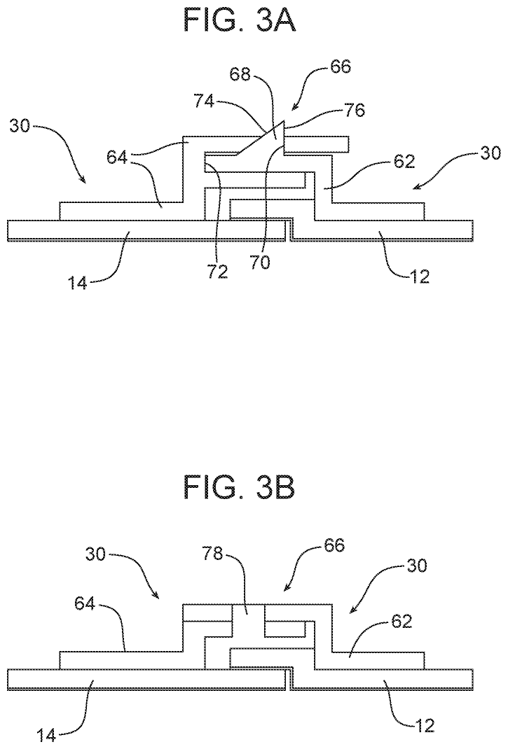

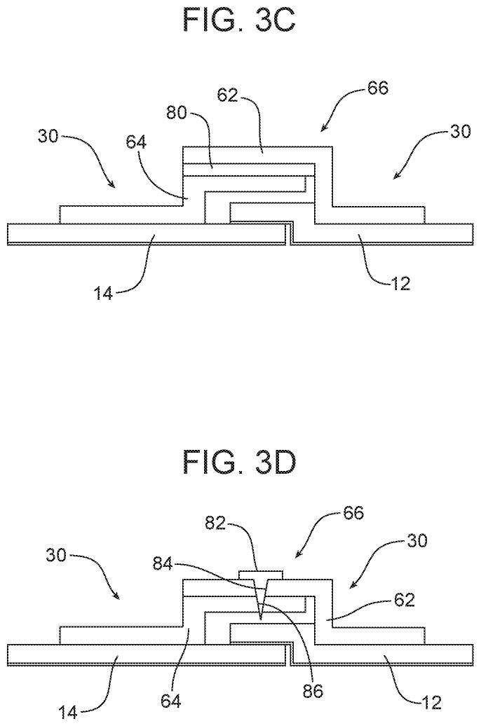

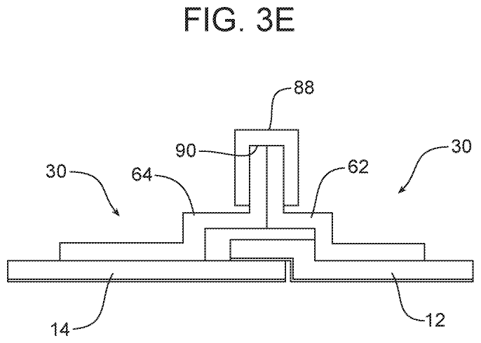

As illustrated in FIGS. 3A-3E, the secondary component 30 may be adapted to function to join the various segments 12, 14, 16, 18 of the headliner 10 together. As illustrated in FIG. 3A, the first segment 12 includes a secondary component 30 comprising a first flange 62 while the second segment 14 includes a secondary component comprising a second flange 64. A fastening feature 66 secures the first segment 12 and the second segment 14 by joining the two flanges 62, 64. More particularly, in the embodiment illustrated in FIG. 3A, the fastening feature comprises a snap tab 68 carried on the first flange 62 and a snap tab receiver 70 carried on the second flange 64. More particularly, the first segment 12 is joined to the second segment 14 by inserting the first flange 62 into the channel 72 of the second flange 64 until the snap tab 68 is received and held in the snap tab receiver 70. Here it should be appreciated that the cam surface 74 of the leading face of the snap tab 68 aids in insertion of the snap tab into the snap tab receiver 70 while the shoulder 76 of the trailing surface resists disconnection.

In the embodiment illustrated in FIG. 3B, the fastening feature 66 is a heat stake 78 joining the overlapping first flange 62 on the first segment 12 with the second flange 64 on the second segment 14.

In the embodiment illustrated in FIG. 3C, the fastening feature 66 is an adhesive 80 joining the juxtaposed surfaces of the overlapping first flange 62 on the first segment 12 and second flange 64 on the second segment 14. That adhesive may, for example, comprise a hot melt.

In the embodiment illustrated in FIG. 3D, the fastening feature 66 comprises a snap fastener 82 received through a first fastener receiver 84 in the first flange 62 of the first segment 12 and a second fastener receiver 86 in the second flange 64 of the second segment 14.

In the embodiment illustrated in FIG. 3E, the fastening feature 66 is a resilient clamp 88 having a channel 90 that receives the overlapping first flange 62 and second flange 64 of the respective first and second segments 12, 14, and positively holds those flanges and segments together.

While FIGS. 3A-3E illustrate various methods and structures for joining the first segment 12 and the second segment 14, it should be appreciated that these same methods and structures may be utilized to join all four segments 12, 14, 16, 18 together as illustrated in FIG. 1.

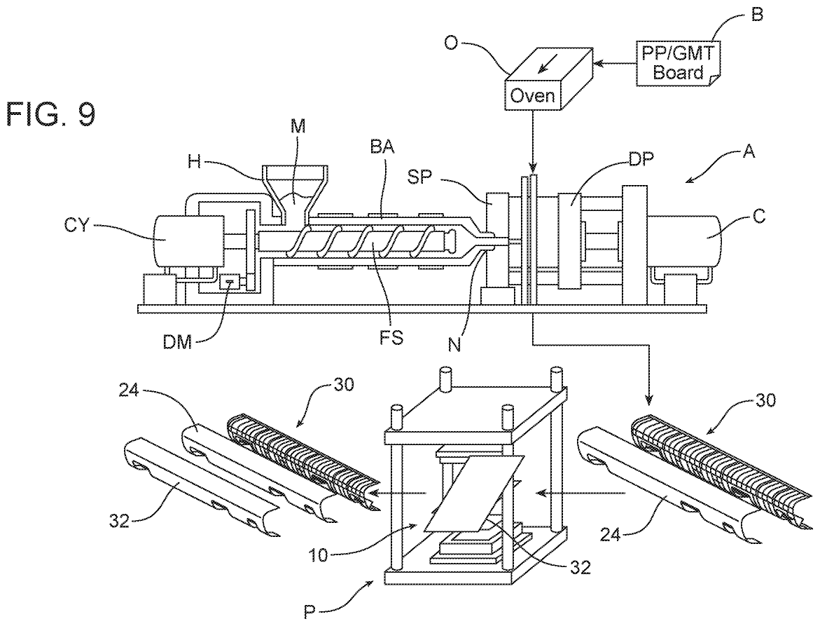

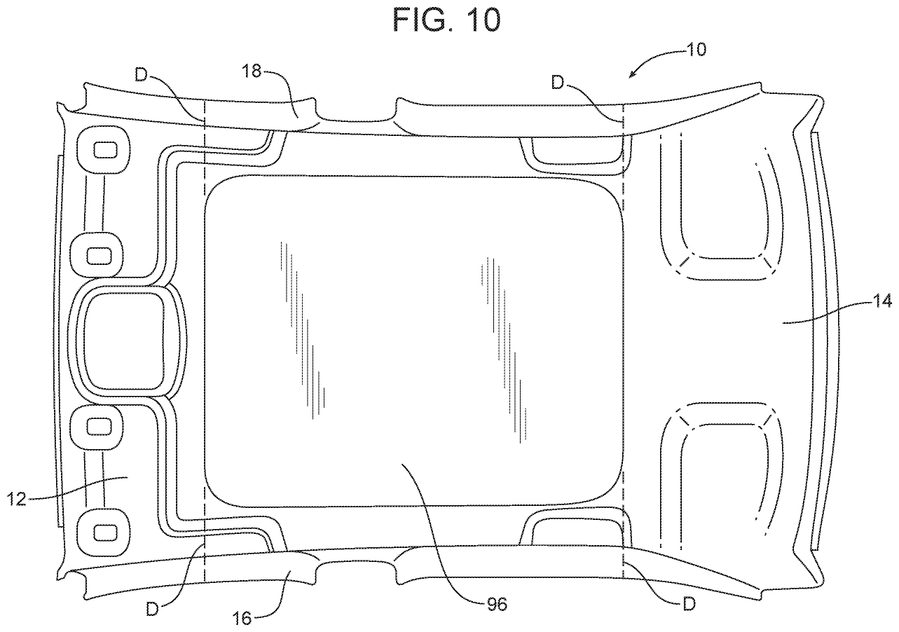

Any of the headliner segments 12, 14, 16, 18 may be produced in the manner schematically illustrated in FIG. 9. As illustrated, a GMT blank B is heated to a desired temperature for processing the blank into the headliner substrate 24. This heating may be performed in the oven O. The preheated blank B is then loaded into the combined thermoforming and injection molding apparatus A.

This is then followed by the step of thermoforming the blank B into the headliner substrate 24 and simultaneously injection molding the secondary component 30 onto the B surface 28 of the headliner substrate. Toward this end, the combined thermoforming and injection molding apparatus A of the illustrated embodiment includes a stationary platen SP and a cooperating displaceable platen DP to complete the thermoforming and compression molding of the blank B into the substrate 24. A clamping cylinder C displaces the displaceable platen DP in the desired manner.

The combined thermoforming and injection molding apparatus A also includes an injection molding section having a feed hopper H, for receiving plastic material in the form of pellets or the like, a feed screw or auger FS for delivering the plastic material M toward the injection molding nozzle N, a drive motor DM for turning the feed screw and a cylinder CY for reciprocating the feed screw through the barrel BA.

The headliner substrate 24 is cured following thermoforming and injection molding and before laminating. In addition, the headliner substrate 24 may be trimmed as necessary following thermoforming and injection molding and before laminating. That trimming may be performed during curing. Further, it should be appreciated that the trimming may include cutting any necessary holes in the headliner substrate 24 as required for the particular motor vehicle application for which the headliner 10 is to be used.

As further illustrated, the headliner substrate 24 may then be transferred from the combined thermoforming and injection molding apparatus A to the laminating press P. This is then followed by the step of laminating the surface covering 32 to the A surface 26 of the headliner substrate 24.

It should be appreciated that more than one segment 12, 14, 16, 18 of the headliner 10 may be processed at a time. For example, FIG. 2 illustrates a first platen 92 for simultaneously forming the first segment/front header 12 and second segment/rear header 14 and a second platen 94 for simultaneously forming the third segment/right hand side rail 16 and fourth segment/left hand side rail 18.

The foregoing has been presented for purposes of illustration and description. It is not intended to be exhaustive or to limit the embodiments to the precise form disclosed. Obvious modifications and variations are possible in light of the above teachings. For example, where the headliner 10 is to be incorporated into a motor vehicle having a full roof, a fifth segment 96 of the headliner may be provided for closing the central opening 20 formed by the first segment 12, second segment 14, third segment 16 and fourth segment 18 (see FIG. 10). The fifth segment 96 may be secured to the first segment 12, second segment 14, third segment 16 and fourth segment 18 in the same manner as the first and second segments are joined together in any of the FIGS. 3A-3E or by other appropriate means.

All such modifications and variations are within the scope of the appended claims when interpreted in accordance with the breadth to which they are fairly, legally and equitably entitled.

What is claimed:

1. A headliner, comprising a plurality of segments connected together and outlining a central opening.

2. The headliner of claim 1, wherein said plurality of segments includes a first segment, a second segment, a third segment and a fourth segment.

3. The headliner of claim 2, wherein said first segment is a front header, said second segment is a rear header, said third segment is a right hand side rail and a fourth segment is a left hand side rail.

4. The headliner of claim 3, wherein each of said plurality of segments comprises a unitary body including (a) a substrate having an A surface and a B surface, (b) a secondary component carried on said B surface and (c) a laminated surface covering on said A surface.

5. The headliner of claim 3, wherein said secondary component comprises (a) a first flange on said first segment of said plurality of segments, (b) a second flange on said second segment of said plurality of segments and (c) a fastening feature securing said first flange and said second flange together in an overlapping relationship.

6. The headliner of claim 3, wherein said fastening feature is a snap tab carried on said first flange and a snap tab receiver carried on said second flange.

7. The headliner of claim 5, wherein said fastening feature is a heat stake fusing said first flange to said second flange.

8. The headliner of claim 3, wherein said fastening feature is an adhesive securing said first flange to said second flange.

9. The headliner of claim 3, wherein said fastening feature is a snap fastener received in a first fastener receiver in said first flange and a second fastener receiver in said second flange.

10. The headliner of claim 3, wherein said fastening feature is a clamp having a channel receiving said first flange and said second flange.

11. The headliner of claim 3, wherein said secondary component on at least one of said right hand side rail and said left hand side rail is a side air curtain deployment feature.

12. The headliner of claim 3, wherein said secondary component on at least one of said plurality of segments is an integral attachment feature.

13. The headliner of claim 3, wherein said integral attachment feature is a bracket.

14. The headliner of claim 3, wherein said bracket includes a receiver adapted to receive a magnetic fastener.

15. The headliner of claim 3, wherein said secondary component on at least one of said plurality of segments is an integral reinforcement.

16. The headliner of claim 3, wherein said integral reinforcement is a plurality of ribs.

17. The headliner of claim 3, wherein said secondary component on at least one of said plurality of segments is an integral energy absorbing feature.

18. The headliner of claim 3, wherein said secondary component on at least one of said plurality of segments is a portion of a trim ring.

19. The headliner of claim 3, wherein said substrate is made from polypropylene.

20. The headliner of claim 3, wherein said secondary component is made from a first material selected from a first group consisting of glass or filled polypropylene and combinations thereof and said surface covering is made from a second material selected from a second group consisting of woven/knit cloth, suede/leather, non-woven material, woodgrain film, metallic film, camo film, carbon fiber film and combinations thereof.
